(19) United States
(12) Patent Application Publication
(10) Pub. No.: US 2009/0161180 A1
(43) Pub. Date: Jun. 25, 2009

(54) PRINTING APPARATUS AND METHOD OF CONTROLLING PRINTING APPARATUS

(75) Inventor: Junpei Nakayama, Kitakyushu-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/340,340

(22) Filed: Dec. 19, 2008

(30) Foreign Application Priority Data
Dec. 19, 2007 (JP) 2007-327074
Nov. 19, 2008 (JP) 2008-295682

(51) Int. Cl. H04N 1/46

(52) U.S. Cl. 358/502

(57) ABSTRACT

A printing apparatus includes a printing unit that ejects ink from nozzles toward a recording medium to thereby perform printing, vibration detection unit that is provided in an apparatus body to detect vibration of the apparatus body, a determination unit that, if vibration is detected by the vibration detection unit while printing by the printing unit is being performed, determines an abnormality, and a display control unit that, if an abnormality is determined by the determination unit, informs a user of the abnormality after the printing has ended, and controls a display unit to display an image that was being printed when the abnormality was determined.

### CROSS REFERENCES TO RELATED APPLICATIONS

The present invention claims priority to Japanese Patent Application No. 2007-327074 filed in the Japanese Patent Office on Dec. 19, 2007 and Japanese Patent Application No. 2008-295682 filed in the Japanese Patent Office on Nov. 19, 2008, the entire contents of each of the above are incorporated herein by reference.

### BACKGROUND

1. Technical Field

The present invention relates to a printing apparatus including a device for detecting vibration of an apparatus body, and to a method of controlling a printing apparatus.

2. Related Art

An printing apparatus that ejects ink onto a recording medium, such as a sheet, from nozzles provided in a head, to thereby perform printing has come into spread (see JP-A-2007-30221). The apparatus described in JP-A-2007-30221 is provided with a mechanism for detecting vibration of the head in the head. If vibration at a predetermined level or more is detected, occurrence of an abnormality is indicated on a display section, and printing is stopped. In this way, the wasteful use of sheets or ink is suppressed. If the vibration becomes less than the predetermined level, resumption of printing is indicated on the display section, and printing is resumed from a printing stop position of an image or from the beginning of the image.

When a user prints a plurality of sheets, in order to attend to another job while printing is being performed, he/she often moves away from the printing apparatus after printing has started. In the apparatus described in JP-A-2007-30221, printing may be stopped and resumed while the user is away. For this reason, when the user comes back after printing has ended, he/she is not informed that printing was stopped since vibration was detected.

### SUMMARY

An advantage of some aspects of the invention is that it provides a printing apparatus that can accurately provide information to a user regarding an image being printed at that time when vibration of an apparatus body becomes a predetermined level or more while printing is being performed, and a method of controlling a printing apparatus.

According to an aspect of the invention, a printing apparatus includes a printing unit that ejects ink from nozzles toward a recording medium to thereby perform printing, vibration detection unit that is provided in an apparatus body to detect vibration of the apparatus body, vibration determination unit that, if vibration at a predetermined level or more is detected by the vibration detection unit while printing by the printing unit is performed, determines an abnormality, and a display control unit that, if an abnormality is determined by the vibration determination unit, informs a user of the abnormality after the printing has ended, and controls a display unit to display an image that was being printed when an abnormality was determined.

With this configuration, if vibration at a predetermined level or more is detected while printing is being performed, and an abnormality is determined, the user is informed of the abnormality after the printing has ended, and an image that was being printed when the abnormality was determined is displayed on the display unit. Therefore, even though the user was away when the abnormality was determined, the user can be accurately provided with information regarding the image that was being printed when the abnormality was determined.

The printing apparatus according to the aspect of the invention may further include an instruction unit that instructs reprinting. The display control unit may control the display unit to display a message requesting the user to select whether or not to reprint the image that was being printed when the abnormality was determined, and if reprinting is instructed by the instruction unit, the printing unit may reprint the image that was being printed when the abnormality was determined.

With this configuration, the message requesting the user to select whether or not to reprint the image that was being printed when the abnormality was determined is displayed on the display unit, and if reprinting is instructed, the image is reprinted. Therefore, the user can select whether or not to reprint the image. For example, like the apparatus described in JP-A-2007-30221, when printing is resumed from the printing stop position of the image, image quality is inevitably deteriorated due to vibration and stop of printing. When the user wants to reprint the image, he/she has to call the image again and to input an instruction to print the image. For this reason, it requires much labor. Meanwhile, when the image is printed again from the beginning, should the user permit the deterioration of image quality, the wasteful use of sheet and ink occurs. As a result, according to the aspect of the invention, the usability of the apparatus can be improved, as compared with the apparatus described in JP-A-2007-30221.

The printing unit may alternately relatively move the nozzles in a main scanning direction and a sub scanning direction substantially perpendicular to the main scanning direction with respect to the recording medium, and ejects ink during the relative movement of the nozzles in the main scanning direction to thereby perform printing. When the image that was being printed when the abnormality was determined is displayed on the display unit, the display control unit may display, on the image, the relative positions of the nozzles in the sub scanning direction with respect to the recording medium when the abnormality was determined.

With this configuration, when the image that was being printed when the abnormality was determined is displayed on the display unit, the relative positions of the nozzles in the sub scanning direction with respect to the recording medium when the abnormality was determined is displayed on the image. Therefore, even though the user is away while printing is being performed, he/she can specify the printing position when the abnormality was determined. As a result, the user can examine around the position to accurately determine whether or not deterioration of image quality is permissible.

The printing apparatus according to the aspect of the invention may further include a cleaning unit that, if an abnormality is determined by the determination unit, cleans the nozzles. With this configuration, if an abnormality is determined while printing is being performed, nozzle cleaning is performed. Therefore, even though nozzle clogging occurs due to vibration, nozzle clogging can be removed, and as a result, printing can be normally performed.

The printing apparatus according to the aspect of the invention may further include a nozzle determination unit that, if an abnormality is determined by the determination unit, determines whether or not the nozzles are able to normally eject ink, and a cleaning unit that, if the nozzle determination unit determines that the nozzles are able to normally eject ink, cleans the nozzles. With this configuration, if an abnormality is determined while printing is being performed, it is determined whether or not the nozzles are able to normally eject ink, and only when the nozzles are unable to normally eject ink, nozzle cleaning is performed. Therefore, unnecessary cleaning can be prevented from being performed.

A method according to another aspect of the invention may be embodied as a program to be executed on a computer or an image compression device.

It should be noted that the above summary of the invention does not enumerate all features necessary for the implementation of the invention; and thus any subcombination of these features can also constitute the invention.

### BRIEF DESCRIPTION OF THE DRAWINGS

The invention will be described with reference to the accompanying drawings, wherein like numbers reference like elements.

FIG. 1 is a perspective view showing a photo printer according to an embodiment of the invention.

FIG. 2 is a diagram showing an overview of an internal configuration of a photo printer.

FIG. 3 is a block diagram showing essential parts of an electrical configuration of a photo printer.

FIG. 4 is a flowchart showing a printing operation procedure.

FIG. 5 is a diagram showing an example of a display screen to be displayed on a display section.

FIG. 6 is a diagram showing an example of a display screen to be displayed on a display section.

FIG. 7 is a diagram showing an example of a display screen to be displayed on a display section.

FIG. 8 is a diagram showing an example of a display screen to be displayed on a display section.

FIG. 9 is a diagram showing an example of a display screen to be displayed on a display section.

### DESCRIPTION OF EXEMPLARY EMBODIMENTS

Although the invention is described below through an exemplary embodiment thereof, the specific embodiment described below is not intended to limit the scope of the invention recited in the appended claims and thus should in no case be understood to be restrictive thereof; nor is it always necessary to encompass all of features and/or a combination(s) thereof that are discussed in the following embodiment as means for solving the problem identified by the invention.

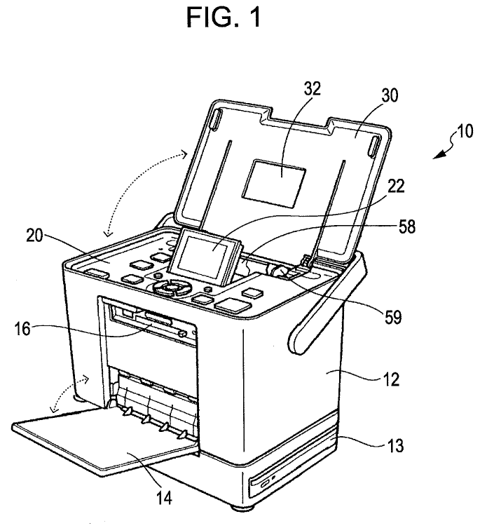

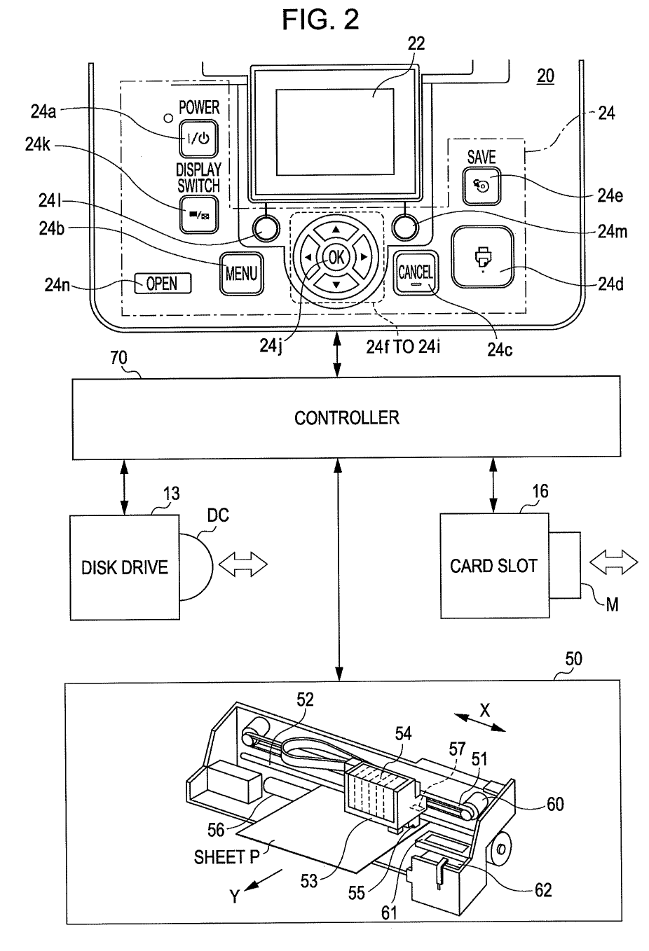

FIG. 1 is a perspective view showing a photo printer as an embodiment of a printing apparatus according to the invention. FIG. 2 is a diagram showing an overview of an internal configuration of a photo printer. A photo printer 10 is provided with a print mechanism section 50 in a printer body (apparatus body) 12, and performs printing on a sheet (recording medium) P in accordance with an operation instruction from a controller 70, which controls the photo printer 10. The printed sheet is discharged to the front surface of the printer body 12.

As shown in FIG. 1, a front cover 14 is openably attached to the front surface of the printer body 12. The front cover 14 is a cover for opening/closing the front surface of the printer body 12. In an open state, the front cover 14 functions as a sheet discharge tray for receiving the sheet P to be discharged from the print mechanism section 50. In this case, a user can use various memory card slots 16 which are provided in the front surface of the printer body 12. That is, in this state, the user can insert a memory card M, in which an image file to be printed is stored, into a memory card slot 16. In this embodiment, in addition to a memory card, a disk DC, such as CD-ROM/R/RW (Compact Disc) or DVD-ROM/R/RW (Digital Versatile Disc), may be used as a storage medium. A disk drive 13 is provided in a base portion of the printer body 12.

An operation panel 20 is provided on a top surface of the printer body 12, and a cover 30 is openably attached to a depth side of the top surface of the printer body 12. The cover 30 is a resin plate of a size sufficient to cover the top surface of the printer body 12. When the cover 30 is open, the surface of the operation panel 20 is exposed to the outside (see FIG. 1). If the cover 30 is closed, the entire operation panel 20 is covered.

The operation panel 20 includes a display section 22, such as an LCD display, for displaying characters, figures, and symbols, and a button group 24 provided around the display section 22. As shown in FIG. 2, the button group 24 includes a power button 24a for turning on/off power, a menu button 24b for calling a main menu screen, a cancel button 24c for canceling an operation or stopping printing on the sheet P, a print button 24d for instructing printing on the sheet P, a save button 24e for saving data in a memory card M inserted into a memory card slot 16, up, down, left and right buttons 24f to 24i which are used to select a desired option from among a plurality of options displayed on the display section 22 or to move a cursor, an OK button 24j which is provided at the center of the up, down, left, and right buttons 24f to 24i and is used to instruct decision of an option to be selected by using the buttons 24f to 24i, a display switch button 24k for switching between screens displayed on the display section 22, a left guide selection button 241 which is used to select a left guide to be displayed on the display section 22, a right guide selection button 24m which is used to select a right guide to be displayed on the display section 22, and a sheet discharge tray open button 24n for opening the front cover 14 functioning as a sheet discharge tray.

A window 32 having the same size as the display section 22 is provided in the cover 30 to allow the user to view the display contents of the display section 22. That is, when the cover 30 is closed, the user can view the display contents of the display section 22 through the window 32. When the cover 30 is open, as shown in FIG. 1, the display section 22 may be adjusted to a desired angle.

When the cover 30 is open, the cover 30 is held so as to be inclined backward with respect to the operation panel 20, and is used as a tray for feeding the sheet P to the print mechanism section 50. On the depth side of the operation panel 20, a sheet feed port 58 of the print mechanism section 50 is provided. In addition, a pair of sheet guides 59 are provided so as to slide in a left-right direction such that the width between the guides can be adjusted to match the width of the sheet.

The sheet P is fed to the print mechanism section 50 through the sheet feed port 58 and printing is performed. In the print mechanism section 50, as shown in FIG. 2, a timing belt 51 is stretched in a loop shape in a left-right direction (main scanning direction X). If a belt roller 60 is driven and the timing belt 51 rotates, a carriage 53 fixed to the timing belt 51 reciprocates in the left-right direction along a guide 52. A sheet end detection sensor 57 is provided in the carriage 53 to detect the left and right ends or the upper and lower ends of the sheet P. That is, the sheet end detection sensor 57 detects the left and right ends of the sheet set in the sheet feed port 58 when the carriage 53 scans in the left and right directions with respect to the sheet before printing, to thereby recognize the width of the sheet, or detects the rear end of the sheet while printing is being performed, to thereby recognize the length of the sheet.

Ink cartridges 54 individually containing ink of respective colors of cyan, magenta, yellow, and black are mounted on the carriage 53, and a printing head 55 is provided in the lower surface of the carriage 53. The ink cartridges 54 are individually connected to the printing head 55. The printing head 55 applies pressure to ink supplied from the ink cartridges 54 and ejects ink from the nozzles in the lower surface thereof toward the sheet P. In this embodiment, the printing head 55 applies a voltage to a piezoelectric element to deform the piezoelectric element and pressurize ink. Alternatively, a voltage may be applied to a heating resistive element (for example, a heater) to heat the ink, and the ink may become pressurized by air bubbles due to the heat. The printed sheet P is transported by a transport roller 56 in a sub scanning direction Y, and is sent to the front cover (sheet discharge tray) 14 in the open state. A standby position of the carriage 53 reciprocating in the left-right direction is provided at the right end. Below the standby position are provided a cap 61 that covers the nozzles of the printing head 55 to be exposed from the lower surface of the carriage 53, and an ink absorption mechanism 62 that absorbs and discards thickened ink in the nozzles of the printing head 55 through the cap 61.

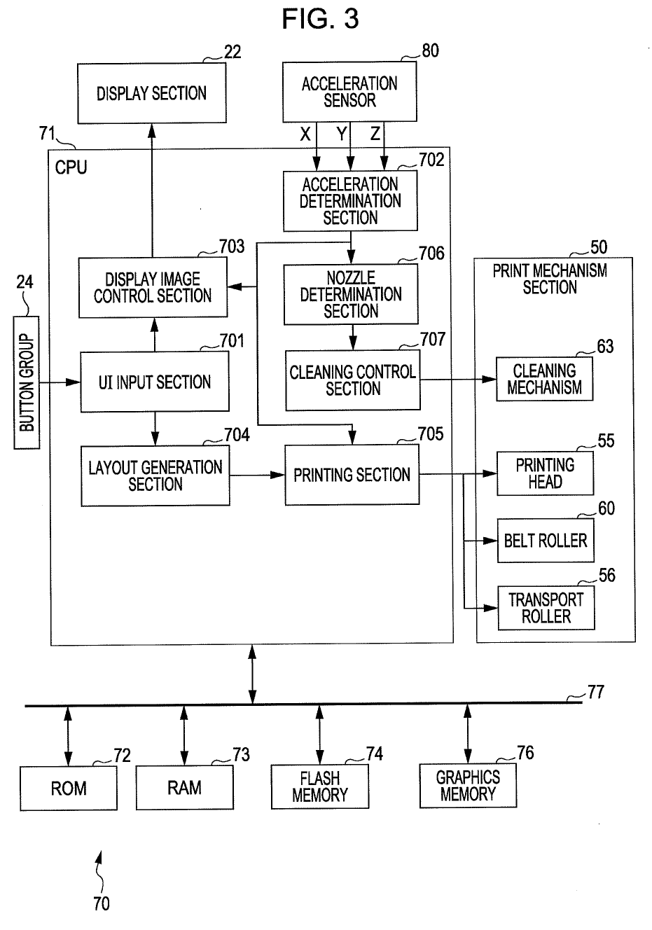

Though not shown, a battery pack is mountable in the rear surface of the printer body 12, and thus the printer 10 may be operated by a battery without being connected to a commercial power supply. In view of this point and that the printer 10 is a stand-alone printer which is usable without being connected to a host computer, the printer 10 is portable and usable anywhere. An acceleration sensor 80 (see FIG. 3) is provided at an appropriate position inside the printer body 12.

FIG. 3 is a block diagram showing essential parts of an electrical configuration of the photo printer. As shown in FIG. 3, the controller 70 is formed by a microprocessor based on a CPU 71. The controller 70 includes a ROM 72 that stores various process programs, various kinds of data, and various tables, a RAM 73 that temporarily stores data, a flash memory 74 that is electrically rewritable and holds data even after power is cut off, and a graphics memory 76 that stores data of an image to be displayed on the display section 22. All of them are connected so as to exchange signals through a system bus 77. As shown in FIG. 2, the controller 70 receives an image file from the memory card M or a disk DC, and a detection signal from the sensor 57 of the print mechanism section 50 or an instruction signal from the button group 24 of the operation panel 20. The controller 70 stores an image or data in the memory card M, and outputs a control signal to the printing head 55 of the print mechanism section 50 or outputs a control signal to the display section 22 of the operation panel 20.

The photo printer includes an acceleration sensor 80, and detects vibration applied to the photo printer by using the acceleration sensor 80. The acceleration sensor 80 detects acceleration in three directions (in this embodiment, for example, the main scanning direction X, the sub scanning direction Y, and the vertical direction Z), and sends a detection signal in accordance with the acceleration value of each direction to the controller 70. A cleaning mechanism 63 of the print mechanism section 50 includes the cap 61 and the ink absorption mechanism 62, and cleans the nozzles of the printing head 55.

A user interface (UI) input section 701 of the CPU 71 receives various instruction signals based on the switch operations performed by the user using the button group 24, and sends necessary information to other functional blocks. An acceleration determination section 702 determines an abnormal acceleration if acceleration at a predetermined level or more is detected on the basis of a detection signal from the acceleration sensor 80. A display image control section 703 controls the display contents of the display section 22 on the basis of information from the UI input section 701 or data from the memory card M. In addition, if the acceleration determination section 702 determines an abnormal acceleration while printing is being performed, the display image control section 703 displays various messages for the user. If the acceleration determination section 702 determines an abnormal acceleration while printing is being performed, the display image control section 703 informs the user of the abnormal acceleration after printing has ended, displays, on the display section 22, an image that was being printed when the abnormal acceleration was determined, and requests the user to select whether or not to reprint the image.

A layout generation section 704 generates layout data for printing on the basis of information from the UI input section 701 or data from the memory card M, and sends layout data to a printing section 705. The printing section 705 converts layout data from the layout generation section 704 into print data, and controls the operation of the print mechanism section 50 to perform printing. That is, the printing section 705 controls the driving of the belt roller 60 to reciprocate the carriage 53 in the main scanning direction X, and controls the driving of the printing head 55 to eject ink from the nozzles. In addition, each time forward or backward movement of the carriage 53 in the main scanning direction X ends (pass), the printing section 705 controls the driving of the transport roller 56 to transport the sheet P in the sub scanning direction Y by a predetermined distance. In addition, if the acceleration determination section 702 determines an abnormal acceleration, the printing section 705 stops ejecting ink from the printing head 55 after the corresponding pass has ended, and stops the carriage 53 at the standby position. If the button group 24 is operated, and an instruction to reprint an image that was being printed when the abnormal acceleration was determined is input, the layout generation section 704 and the printing section 705 perform control to reprint the image.

If the acceleration determination section 702 determines an abnormal acceleration, the nozzle determination section 706 determines whether or not ink is normally ejected from the nozzles of the printing head 55. In this embodiment, like an automatic nozzle checking system in the ink jet printer PX-20000 manufactured by Seiko Epson Corporation, a dead dot is automatically checked by voltage control.

A cleaning control section 707 controls the operation of the cleaning mechanism 63. When the photo printer 10 starts or when a new ink cartridge 54 is mounted, the cleaning control section 707 performs nozzle cleaning by capping the printing head 55 with the cap 61 and absorbing ink through the ink absorption mechanism 62. In addition, if the nozzle determination section 706 determines a dead dot, the cleaning control section 707 performs nozzle cleaning.

In this embodiment, the button group 24 corresponds to an “instruction unit” of the invention, the acceleration sensor 80 corresponds to an “acceleration detection unit” of the invention, the acceleration determination section 702 corresponds to an “acceleration determination unit” of the invention, the display image control section 703 corresponds to a “display control unit” of the invention, and the nozzle determination section 706 corresponds to a “nozzle determination unit” of the invention. The printing section 705 and the print mechanism section 50 form a “printing unit” of the invention, and the cleaning control section 707 and the cleaning mechanism 63 form a “cleaning unit” of the invention.

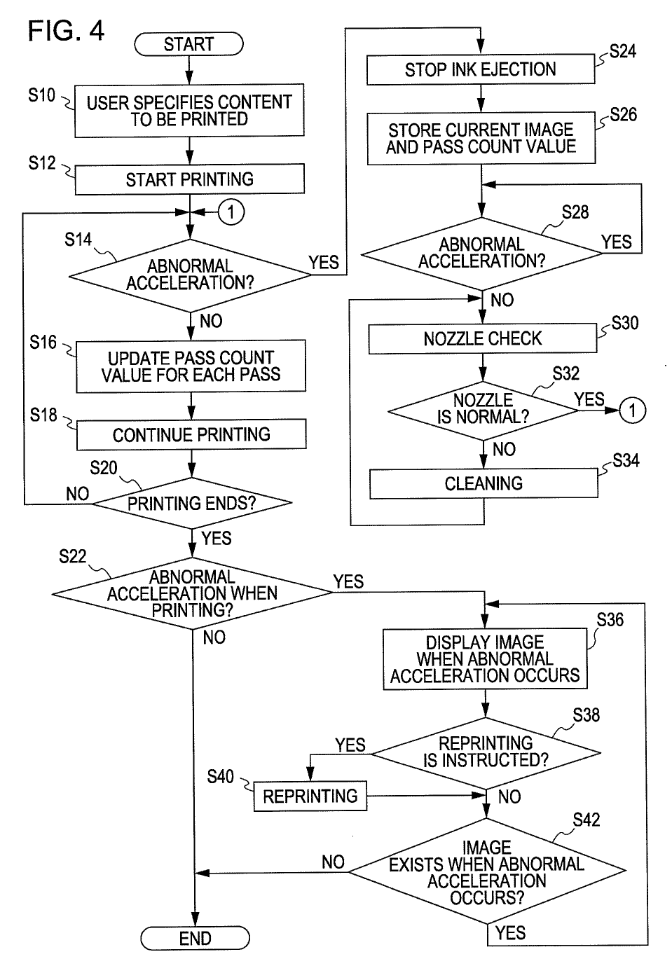

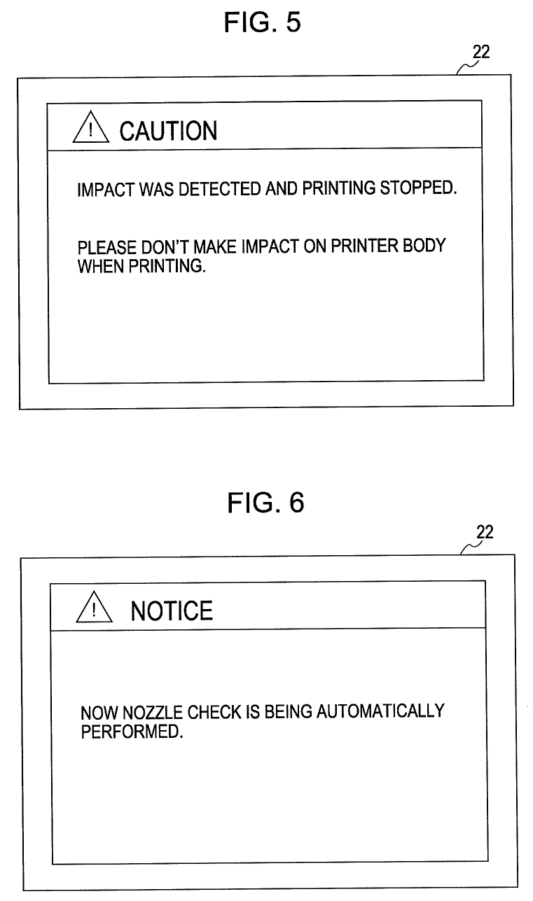

FIG. 4 is a flowchart showing a printing operation procedure. FIGS. 5 to 9 are diagrams showing examples of a display screen to be displayed on the display section 22. Referring to FIG. 4, if the user operates the button group 24 to assign an image to be printed or the number of copies (Step S10), printing is started (Step S12). Next, it is determined whether or not the acceleration determination section 702 determines an abnormal acceleration (Step S14: acceleration determination step). If the abnormal acceleration is not determined (NO in Step S14), each time the forward or backward movement of the carriage 53 in the main scanning direction X ends (pass), a pass count value is updated (Step S16), and printing is continued (Step S18). Until printing assigned by the user in Step S10 ends (NO in Step S20), the process returns to Step S14 and the above procedure is repeatedly performed. That is, if printing ends for one sheet P, the pass count value is reset to 0, and the sheet P is discharged. Then, if a next sheet P is fed, printing is started for the next sheet P.

If the abnormal acceleration is determined while printing is being performed (YES in Step S14), ink ejection is stopped after the corresponding pass ends, and the carriage 53 returns to the standby position and is stopped. Then, a message shown in FIG. 5 is displayed on the display section 22 (Step S24). Next, an image being currently printed and a current pass count value are stored in the RAM 73 (Step S26). The process waits while the abnormal acceleration continues (YES in Step S28). Then, if the abnormal acceleration is released (NO in Step S28), nozzle checking is carried out by the nozzle determination section 706, and a message shown in FIG. 6 is displayed on the display section 22 (Step S30).

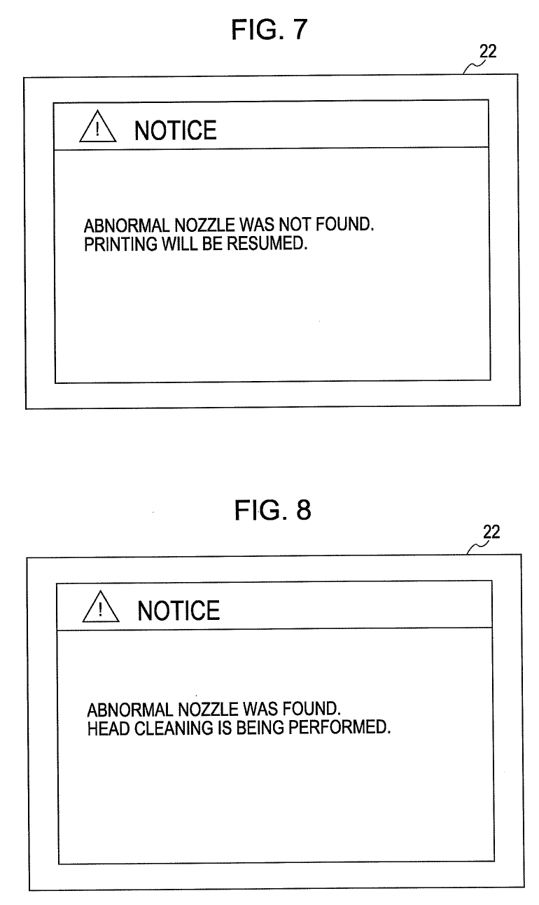

If the nozzles are normal (YES in Step S30), the process returns to Step S14, printing is resumed, and a message shown in FIG. 7 is displayed on the display section 22. If any nozzle is abnormal (NO in Step S30), nozzle cleaning is performed, and a message shown in FIG. 8 is displayed on the display section 22 (Step S34). Then, the process returns to Step S30, and the above procedure is repeatedly performed. If the number of repetitions of Steps S30, S32, and S34 reaches a predetermined number of times, the reason may be displayed on the display section 22, and the photo printer 10 may be stopped.

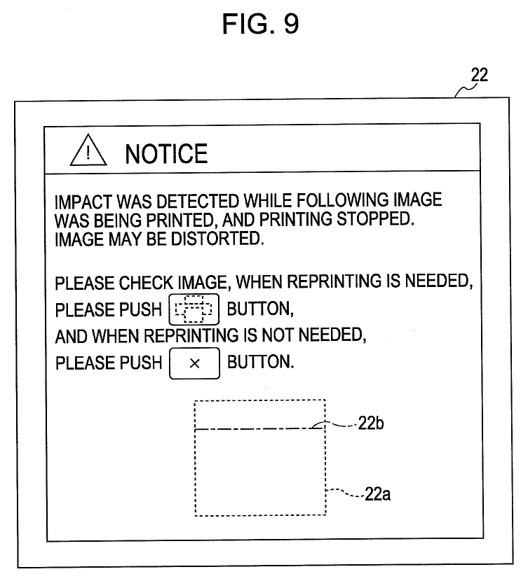

If printing commanded by the user in Step S10 ends (YES in Step S20), it is determined whether or not the abnormal acceleration occurs while printing is being performed (Step S22). If the abnormal acceleration is not determined (NO in Step S22), the routine ends. When the abnormal acceleration occurs while printing is being performed (YES in Step S22), as shown in FIG. 9, the user is informed of the fact that the abnormal acceleration occurred while printing was being performed on the basis of the image and the pass count value stored in Step S26. Then, an image 22a that was being printed when the abnormal acceleration occurred and a pass 22b are displayed on the display section 22, and a message requesting the user to select whether or not to reprint the image is displayed (Step S36: display control step).

If the button group 24 is operated and an instruction to reprint the image is input (YES in Step S38), the image is reprinted and the process progresses to Step S42 (Step S40). If an instruction indicating that reprinting is not necessary is input (NO in Step S38), it is determined whether or not there was an image being printed when the abnormal acceleration occurred (Step S42). If an image existed (YES in Step S42), the process returns to Step S36, and the above-described steps are repeatedly executed. If no image existed (NO in Step S42), the routine ends.

As described above, according to this embodiment, when the abnormal acceleration is determined while printing is being performed, a message informing the user of the fact that the abnormal acceleration occurred is displayed on the display section 22 after printing ends, and the image 22a that was being printed when the abnormal acceleration was determined is displayed. Therefore, even though the user was away when the abnormal acceleration was determined, the user can be accurately provided with information regarding an image when the abnormal acceleration was determined.

According to this embodiment, a message requesting the user to select whether or not to reprint an image that was being printed when the abnormal acceleration was determined is displayed on the display section 22, and if the button group 24 is operated and an instruction to reprint the image is input, the image is reprinted. Therefore, the user can easily reprint the image when the abnormal acceleration was determined. In addition, when the user can permit deterioration of image quality, reprinting is not performed, and thus wasteful use of sheets and ink can be suppressed. As a result, the usability of the photo printer 10 can be improved.

According to this embodiment, when the image 22a that was being printed when the abnormal acceleration was determined is displayed on the display section 22, the pass 22b based on the pass count value is displayed so as to overlap the image 22a. Therefore, even though the user is away while printing is being performed, he/she can specify a printing position when the abnormal acceleration was determined. As a result, the user can examine around the position to accurately determine whether or not deterioration of image quality is permissible.

According to this embodiment, if an abnormal acceleration is determined while printing is being performed, nozzle cleaning is performed. Therefore, even though nozzle clogging occurs due to acceleration, nozzle clogging can be eliminated, and printing can be normally performed. According to this embodiment, the nozzle determination section 706 performs nozzle checking, and only when it is determined that a nozzle is abnormal, nozzle cleaning is performed. As a result, unnecessary nozzle cleaning can be prevented from being performed.

The invention is not limited to the foregoing embodiment, but various changes or modifications may be made without departing from the scope of the invention. For example, in the foregoing embodiment, the nozzle determination section 706 performs nozzle checking, and only when a nozzle is abnormal, nozzle cleaning is performed. However, the invention is not limited thereto. For example, nozzle cleaning may be performed while nozzle checking is not performed. In this case, the nozzle determination section 706 is not provided. The nozzle checking method of the nozzle determination section 706 is not limited to the foregoing embodiment, but other nozzle checking method may be used.

In the foregoing embodiment, when an abnormal acceleration is determined, ink ejection is stopped after the corresponding pass has ended. Therefore, a position at which printing is to be resumed can be easily specified. However, the invention is not limited thereto. For example, if the abnormal acceleration is determined during the pass, ink ejection may be immediately stopped. Therefore, defective printing can be reliably suppressed. In this case, if the stop position of ink ejection in the main scanning direction X is stored in the RAM 73, the position at which printing is to be resumed can be specified.

In the foregoing embodiment, mainly in order to discharge thickened ink and air bubbles in the ink flow channel, cleaning is performed by capping the printing head 55 with the cap 61 and absorbing ink from the nozzles through the ink absorption mechanism 62. However, the invention is not limited thereto. Alternatively, cleaning may be performed by wiping ink stuck to the surface of the head with a rubber wiper, wiping ink stuck to the surface of the head with a sponge, or performing flushing (ejection) to eject a predetermined amount of ink to the cap 61 or a non-printing area. In addition, the above methods may be used in combination. For example, first cleaning may be performed by flushing, and second cleaning may be performed by absorption through the absorption mechanism 62. It is clear and obvious for a person skilled in the art that the above embodiments of the invention may be subjected to various modifications or improvements thereof. From the description of the appended claims, it is clear and obvious that such a modified or improved mode still falls within the technical scope of the invention.

In the foregoing embodiment, vibration is detected by the acceleration sensor, but various sensors (a sensor using an optical fiber, a sensor using vibration of a string, a sensor using a magnet, and a sensor using a gyroscope) are known. Therefore, it is clear that a mode using a sensor other than an acceleration sensor still falls within the technical scope of the invention.

What is claimed is:

1. A printing apparatus comprising:
a printing unit that ejects ink from nozzles toward a recording medium to thereby perform printing;
vibration detection unit that is provided in an apparatus body to detect vibration of the apparatus body;
a determination unit that, if vibration is detected by the vibration detection unit while printing by the printing unit is performed, determines an abnormality; and
a display control unit that, if an abnormality is determined by the determination unit, informs a user of the abnormality after the printing has ended, and controls a display unit to display an image that was being printed when the abnormality was determined.

2. The printing apparatus according to claim 1, further comprising:
an instruction unit that instructs reprinting,
wherein the display control unit controls the display unit to display a message requesting the user to select whether or not to reprint the image that was being printed when the abnormality was determined, and
if reprinting is instructed by the instruction unit, the printing unit reprints the image that was being printed when the abnormality was determined.

3. The printing apparatus according to claim 1,
wherein the printing unit alternately relatively moves the nozzles in a main scanning direction and a sub scanning direction substantially perpendicular to the main scanning direction with respect to the recording medium, and ejects ink during the relative movement of the nozzles in the main scanning direction to thereby perform printing, and
when the image that was being printed when the abnormality was determined is displayed on the display unit, the display control unit displays, on the image, the relative positions of the nozzles in the sub scanning direction with respect to the recording medium when the abnormality was determined.

4. The printing apparatus according to claim 1, further comprising:
a cleaning unit that, if an abnormality is determined by the determination unit, cleans the nozzles.

5. The printing apparatus according to claim 1, further comprising:
a nozzle determination unit that, if an abnormality is determined by the determination unit, determines whether or not the nozzles are able to normally eject ink; and
a cleaning unit that, if the nozzle determination unit determines that the nozzles are unable to normally eject ink, cleans the nozzles.

6. A method of controlling a printing apparatus, the method comprising:
if vibration is detected while ink is being ejected from nozzles toward a recording medium, to thereby perform printing, determining an abnormality; and
if an abnormality is determined in the determining of the abnormality, informing a user of the abnormality after printing has ended, and controlling a display unit to display an image that was being printed when the abnormality was determined.
